(19) United States
(12) Patent Application Publication
(10) Pub. No.: US 2014/0311576 A1
(43) Pub. Date: Oct. 23, 2014

(54) Integrated Hydraulic Accumulator Dual Shut-Off Valve

(71) Applicant: Charles L. Gray, JR., Pinckney, MI (US)

(72) Inventor: Charles L. Gray, JR., Pinckney, MI (US)

(21) Appl. No.: 13/865,319

(22) Filed: Apr. 18, 2013

(51) Int. Cl. B60K 6/12; F15B 1/02

(52) U.S. Cl. CPC B60K 6/12; F15B 1/024
USPC 137/1; 137/561 R

(57) ABSTRACT

An integrated shut-off valve unit for a hydraulic accumulator comprises primary and secondary shut-off valves. In a first closed state, where only the primary shut-off valve is closed, auxiliary portions of a hydraulic circuit are energized without energizing the power-producing portion. In a second closed state, both valves are closed, isolating all portions of the circuit. The valve unit is opened from the first closed state by equalizing pressure across the primary shut-off valve and commanding it open. The valve unit is opened from the second closed state by pumping fluid across the secondary valve toward the hydraulic accumulator.

### CROSS-REFERENCE TO RELATED APPLICATIONS

This application claims priority to U.S. Provisional Application 61/635,085, “Integrated Hydraulic Accumulator Dual Shut-Off Valve,” filed Apr. 18, 2012.

### BACKGROUND OF THE INVENTION

1. Technical Field

The disclosed embodiments are directed generally to fluid power systems for hydraulic hybrid vehicles, and, in particular, to fluid shut-off valves that are configured to isolate vehicle hydraulic systems from high pressure fluid when desired while allowing for safe and convenient repressurization of the vehicle hydraulic systems.

2. Description of the Related Art

In recent years there has been interest in the development of hydraulic hybrid vehicles. According to one configuration, a series hydraulic hybrid vehicle employs an internal combustion engine (ICE) to drive a hydraulic pump, which pressurizes hydraulic fluid. The pressurized fluid is then either used to drive a hydraulic motor coupled to the drive wheels of the vehicle, or stored in a high pressure accumulator for later use.

In practice with hydraulic hybrid vehicles, it is known to provide the high pressure accumulator with an isolating means (e.g., a shut-off valve) by which the high pressure accumulator may be hydraulically isolated from the rest of the hydraulic circuit when the vehicle is shut down or an abnormal operating condition is detected. There are also safety considerations related to shutting down and powering up such a vehicle that utilize over-center pump/motors. For example, before pressure is restored, all pump/motors should be ensured to be at zero displacement. Because the zero displacement position of an over-center pump/motor is not physically definite, it is possible that the displacement could change while the vehicle is shut down even if they were set to zero on shutdown. If they are not at zero on startup, it may be impossible to return them to zero displacement without access to the high pressure accumulator to provide actuation pressure. For these reasons the accumulator shut-off mechanism is an important factor in the safety of a hydraulic hybrid vehicle.

### OBJECT OF THE INVENTION

It is therefore an object of the invention to provide a compact, safe, effective and low cost device for isolation of a hydraulic accumulator from a hydraulic power circuit.

It is another object of the invention to provide such a device that also provides for pre-pressurization of the hydraulic circuit for pump/motor displacement actuation purposes and noise reduction purposes without opening the power-producing part of the circuit to high pressure.

### SUMMARY OF THE INVENTION

The invention is an integrated fluid supply valve unit configured to control flow between a high pressure fluid supply and a power-producing hydraulic power circuit. The integrated valve unit comprises a first (primary) shut-off valve and a second (secondary) shut-off valve integrated into a single device. As used herein, “integrated” means that the primary and secondary shut-off valve members in the valve unit are combined into a common housing. Separate passages are provided for pressurization of portions of the hydraulic circuit prior to pressurization of the power-producing portion of the circuit.

A first valve is a primary shut-off valve that can isolate the power-producing portion of the circuit from the high pressure source by shutting off fluid flow toward the circuit, without isolating other portions of the circuit. A spring force causes the valve to default to a closed position when its ports are at equal pressure and pressure is supplied to an actuating pilot chamber. The valve opens by pressure equalizing across the inlet and outlet ports of the valve, and then dumping pressure from a pilot chamber.

A second valve is a secondary shutoff valve that can isolate the entire valve unit and hence all its connected circuits from the high pressure source. A spring force causes the valve to default to an open position except under conditions of high outflow from the high pressure source or when the valve is commanded closed, such as required far servicing or in case of system malfunction. The valve is commanded closed by dumping pressure from a pilot chamber, allowing pressure at the valve member to overcome the spring force and shut the valve. The valve is opened by pumping, fluid into the high pressure source and is then held open by pressurizing the pilot area and by force of the spring.

For a first embodiment, normally the secondary valve will remain open at all times and only the primary valve closes to protect the power-producing portion of the circuit during short term shutdown. The secondary valve only closes for longer term shutdowns, for example, for servicing, or when a system malfunction is detected, or to act as flow fuse under high flow conditions such as might be caused by a line break. Therefore, for the first embodiment, upon startup the secondary valve will already be open and only the primary valve needs to be opened. Another embodiment provides for the primary and secondary valves to both close normally upon shutdown. Upon startup, both valves will need to be opened, as will be described later.

To start up the system when the primary valve is closed and the secondary valve is open, the primary valve is opened in a systematic manner to prevent actuation noise, after first pre-setting any connected pump/motors to zero displacement by pressurization of an actuation circuit that is separate from the power-producing circuit. First, a valve to the actuation circuit is opened. This provides pressure to the actuation circuit, and the pump/motors are then commanded to zero displacement. Once the pump/motors have achieved zero displacement, the primary valve is opened by the following sequence. First, pressure is equalized across the inlet and outlet of the primary valve by means of a pressurization valve that connects these segments of the circuit. Then, the primary valve pilot chamber, which is normally initially at high pressure, is opened to low pressure. The high pressure active at the inlet and outlet then drives the primary valve to an open state against the pressure of an internal spring. The primary valve stays in the open position as long as high pressure is active at the ports and low pressure is active at the pilot chamber.

To start up the system when both the primary valve and the secondary valve are closed, a charge pump or similar pressurization means provides pressure to an actuation circuit, which is separate from the other circuits which can be pressurized, to first preset any connected pump/motors to zero displacement. The hydraulic circuit is then pressurized downstream by an engine pump or similar mechanical pressurization, and fluid is driven through the circuit into the high pressure source. This causes the primary and secondary valves to open by force of fluid flow. The primary valve is kept open by commanding low pressure to its pilot chamber. The secondary valve is kept open by commanding high pressure to its pilot chamber, and by the spring force.

Preferably, the primary shut-off valve is provided as an ordinary cartridge valve. A cartridge valve has a valve member that governs flow by engaging or disengaging with a seat, a spring that would tend to close the valve by pushing the valve member against the seat, a pilot pressure acting on a pilot area that would also tend to push the valve member against the seat, and two port pressures that would tend to open the valve by pushing the valve member away from the seat. When both ports and the pilot area are at an equal pressure, the valve will be closed, because although the pressures acting on the valve member are equal, the spring still exerts a net force that closes it. When the two ports have high pressure but the pilot chamber is dumped to low, it opens by pressure on the ports.

Preferably, the secondary shut-off valve is provided as a tulip valve. A tulip valve has a valve member that governs flow by engaging or disengaging with a seat, a spring that would tend to open the valve by pushing the valve member away from the seat, a pilot pressure acting on a pilot area that would tend to balance pressure around the valve member allowing it to normally remain open by the spring force, and a valve member that under a predetermined very high fluid flow pressure would tend to close the valve by pushing the valve member toward the seat by compressing the spring to achieve a “flow fuse” valve closing. When fluid pressure on the valve member and the pilot area are at an equal pressure, the valve is held open by spring force.

### BRIEF DESCRIPTION OF THE DRAWINGS

FIG. 1 is a schematic diagram of an integrated shut-off valve circuit according to invention.

FIGS. 2A-2D are sectional views of a primary shut-off valve component included in the integrated shut-off valve circuit.

FIGS. 3A-3B are sectional views of a secondary shut-off valve component included in the integrated shut-off valve circuit.

FIGS. 4A-4B are sectional views of an exemplary control valve included in the integrated shut-off valve circuit.

FIG. 5 is a partial sectional view of an exemplary integrated shut-off valve unit containing the circuit of FIG. 1.

FIG. 6 is a partial sectional view of the valve unit taken along section A-A of FIG. 5.

FIG. 7 is a partial sectional view of the valve unit taken along section B-B of FIG. 5.

### DETAILED DESCRIPTION

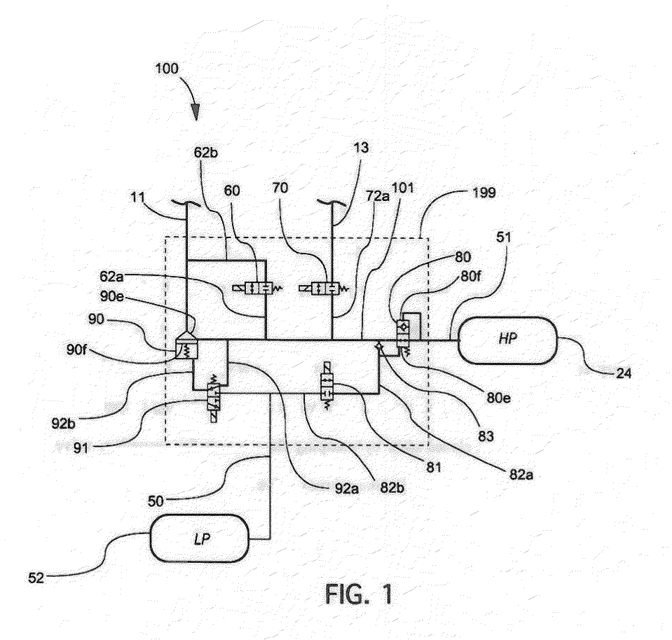

Referring to FIG. 1, valve unit 100 includes integrated common housing 199 (for example, a metal block with borings, or a cast block with cast passages, or a combination, including sections which may be bolted together). Housing 199 provides standard connections to a high pressure accumulator 24, a first high pressure hydraulic line 11, a second high pressure hydraulic line 13, and a low pressure hydraulic line 50. First high pressure line 11 connects with a hydraulic circuit, for example, a power-producing circuit that includes one or more variable displacement pump motors whose power-producing rotating groups are provided with high pressure fluid via line 11. Second high pressure line 13 connects with an actuation circuit that provides high pressure fluid to the displacement actuation means of said pump/motors but not to the power-producing rotating groups. Valve 70 selectively opens or closes actuation line 13 to flow. Low pressure line 50 connects with a low pressure source for the circuit, such as a reservoir, tank, or low pressure accumulator 52 as depicted.

Valve 90 is the primary shut-off valve, providing for shut-off of high pressure fluid to line 11. Valve 90 is configured to take on an open or dosed state by being responsive to several influences including fluid pressures at the valve, a spring force, and by pilot command. Second valve 80 is the secondary shut-off valve, providing for complete shut-off of valve unit 100 from the high pressure accumulator 24. Similarly to valve 90, valve 80 is configured to take on an open or closed state by being responsive to several influences including fluid pressures at the valve, a spring force, and by pilot command.

Valve unit 100 is preferably part of a hydraulic hybrid vehicle. For routine, temporary shutdown of the vehicle in a first embodiment, for example, when the vehicle is parked and the key is taken out, valve unit 100 takes on a first closed state in which primary valve 90 is closed and secondary valve 80 remains open. For longer term shutdown of the vehicle, for example on detection of a system malfunction or for servicing of the hydraulic circuit, or for normal shutdowns in the alternative embodiment, valve unit 100 takes on a second dosed state in which both primary valve 90 and secondary valve 80 are closed.

In normal operation, valve unit 100 is in an open state in which first valve 90 and second valve 80 are both open, thereby allowing high pressure fluid to flow in either direction between high pressure accumulator 24 and high pressure line 11. To provide fluid power to pump/motors on line 11, high pressure fluid flows from accumulator 24, through fluid passage 51, through secondary shut-off valve 80, through internal passage 101, through first primary shut-off valve 90 and into line 11. To charge the accumulator 24, high pressure fluid flows in a reverse direction, from line 11, through valve 90, through internal passage 101, through valve 80, through fluid passage 51, and into accumulator 24.

In a first embodiment, when it is desired that the pump/motors be shut down, such as for example, when a hydraulic hybrid vehicle is parked and the key is taken out, valve unit 100 takes on the first closed state, preventing high pressure fluid from powering the rotating groups of the pump motors but allowing the pump/motor displacement actuation circuit to retain access to high pressure. In this first closed state, primary shut-off valve 90 is in a closed state and secondary valve 80 is in an open state. Actuation line 13 thereby retains access to high pressure for actuation, although the rotating groups cannot be powered via line 11. Preferably, the pump/motors are then actuated to zero displacement. Actuation circuit valve 70 may then be closed to prevent leakage through the displacement actuators.

When it is desired that the entire system be isolated from the high pressure source 24, such as for example when the vehicle is to be serviced or because a malfunction has been detected (or in the second embodiment), valve unit 100 takes on a second closed state in which both primary valve 90 and secondary valve 80 are in closed states. Both line 11 and line 13 are thereby closed to high pressure fluid.

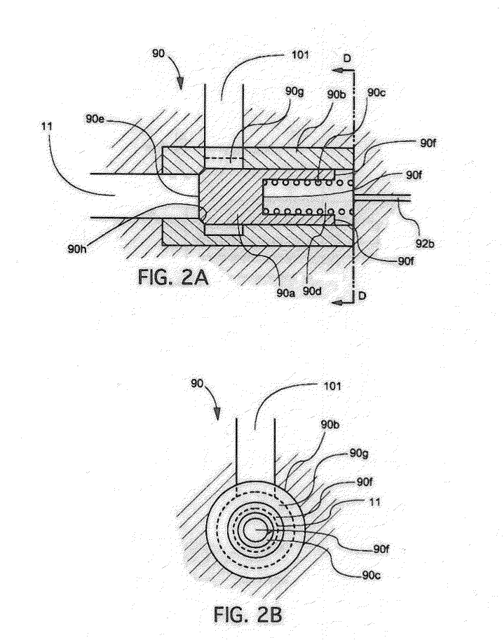

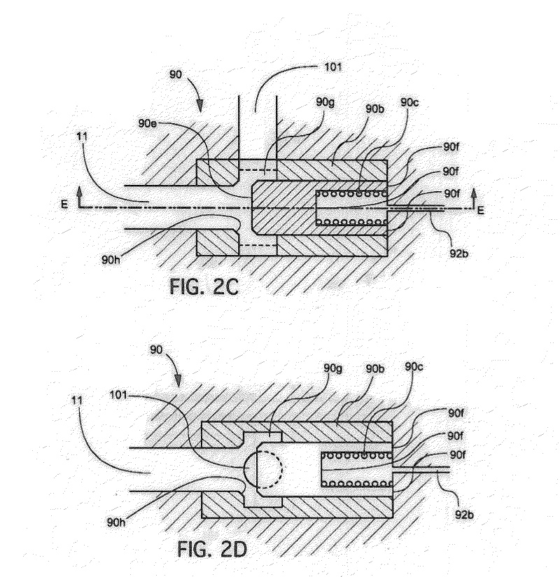

Referring now to FIGS. 2A-2D, a preferred physical configuration for primary valve 90 in the form of a commonly available cartridge valve is detailed. Although a cartridge valve is known art, some of the specific features of such a valve are operative toward the overall functioning of the invention as a unique integrated valve unit and are therefore reviewed here.

Referring to FIGS. 2A-2B, cartridge valve 90 is configured to control flow in either direction between passage 101 and line 11. Valve 90 includes an internal valve member 90a that is slidably disposed within valve body 90b. When seated on valve seat surface 90h (as depicted in FIG. 2A), flow is thereby blocked between passage 101 and line 11. Spring 90c exerts a force urging valve member 90a toward the seat and thereby causes the valve to default to a closed position if all surfaces of the valve member are at equal pressure. Annular passage 90g surrounds valve member 90a and remains in fluid communication with passage 101 even in this closed state.

The state of valve 90 at any given time is determined by the movement of valve member 90a in response to the resultant sum of forces exerted on the member by spring 90c and by fluid pressure at each of first and second surface areas 90e and 90f on the member. First surface area 90e is in fluid communication with line 11 and thereby any fluid pressure in line 11 will urge valve member 90a toward an open state. Second surface area 90f is in fluid communication with chamber 90d. Any pressurized fluid within chamber 90d thereby exerts pressure against surface area 90f urging valve member 90a toward a closed state. The pressure in chamber 90d is determined by the pressure in control line 92b, which is determined by the state of a control valve (shown as valve 91 in FIG. 1) that may be switchably connected to high or low pressure.

In general, when the pressure force at the second area 90f is as high as or higher than the pressure force at the first area 90e, the closing pressure force at the second area 90f cancels or dominates the opening pressure force at area 90e, and valve 90 will be closed, or held closed, by at least the force of the spring if not a portion of the second pressure force. However, when the pressure force at the first area 90e is sufficiently high and the pressure force at the second area 90f is sufficiently low, the opening pressure force at area 90e dominates, and valve 90 will open by fluid pressure against the force of spring 90c. FIGS. 2C-2D depict the valve in an open state. FIG. 2D is an orthogonal section of FIG. 2C taken along line E-E.

Valve 90 can also be pushed open to allow fluid to pass toward the high pressure source by pumping fluid from line 11, in which case the pressure at first area 90e will build until it overcomes the force of spring 90c and any pressure at 90f (with control valve 91 allowing fluid in chamber 90d to escape through line 92b).

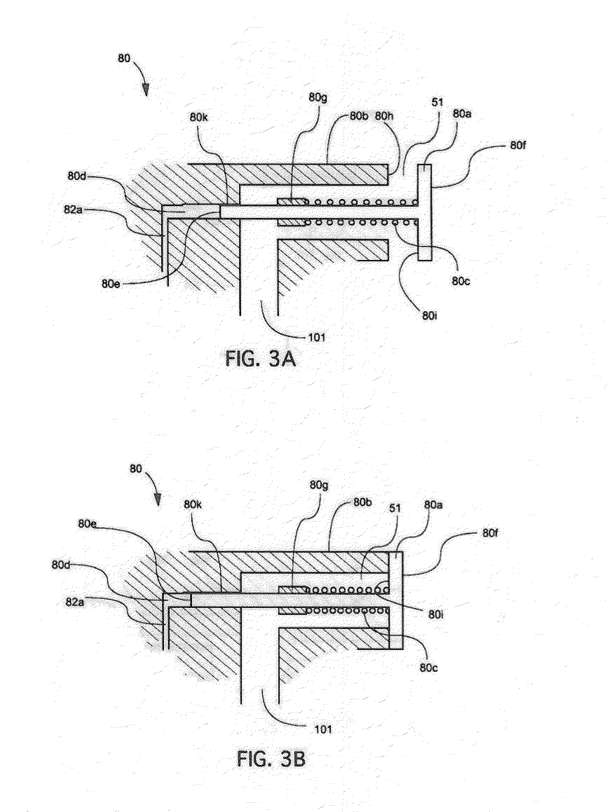

Referring now to FIGS. 3A-3B, a preferred physical configuration for secondary valve 80 is detailed. Valve 80 is preferably a tulip valve that includes an internal valve member 80a that is slidably disposed within valve body 80b, retained and centered by guide 80g. Surface 80f is preferably disposed within the interior of a high pressure accumulator. When seated on valve seat surface 80h (as depicted in FIG. 3B), valve 80 is in a closed state and fluid is thereby blocked from flowing into passage 51 from the high pressure accumulator.

The state of valve 80 at any given time is determined by the movement of valve member 80a in response to the resultant sum of forces exerted on the member by spring 80c and by fluid pressure at each of surface areas 80f, 80i and 80e on the member 80a. First surface area 80f is in fluid communication with the high pressure fluid in the accumulator, and thereby this pressure, if not balanced by other pressures on the member, tends to urge valve member 80a toward a closed state. Second surface area 80e is in fluid communication with chamber 80d, which is typically filled with pressurized fluid from passage 51 by means of clearance 80k (FIG. 3B) which could be, for example, a simple annular clearance or a narrow groove. Fluid may be substantially trapped in chamber 80d if it is prevented (for example, by closure of valve 81 in FIG. 1), from easily leaving through passage 82a, thereby opposing the closure of valve member 80a. Third surface area 80i is responsive to flow into the accumulator, urging member 80a toward an open state when fluid is pumped in. Spring 80c exerts a force tending to urge member 80a toward an open state.

In general, valve 80 is opened by the sum of the spring force and the force of any fluid flow across the member 80a into the high pressure accumulator (primarily experienced at area 80i) and then is retained in an open position by the force of spring 80c, and by fluid in chamber 80d. Valve 80 is closed by dumping, the fluid in chamber 80d, by opening pilot valve 81 (FIG. 1) to low pressure. Pressure at second surface area 80e then rapidly drops, causing the high pressure at the first area 80f to dominate and close member 80a.

Valve 80 can also be closed by flow pressure acting at surface 80f resulting from high flow rates out of the accumulator, in which case it acts as a flow fuse against catastrophic leakage. The spring is sized to a specific stiffness corresponding to the pressure differential that would cause it to compress sufficiently to close, for example, perhaps 150 psi. Check valve 83 (FIG. 1) allows fluid from chamber 80d to easily discharge into volume 101 to avoid resistance to the flow fuse event. Once closed, it is expected that pressure in passage 51 will leak down fairly quickly through other parts of the circuit, causing the pressure force at 80i to be smaller than the opposing force at 80f, keeping the valve shut.

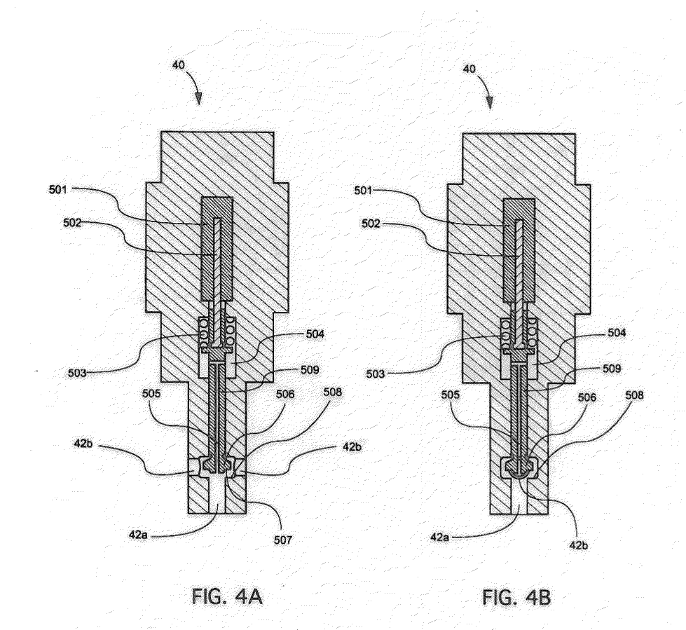

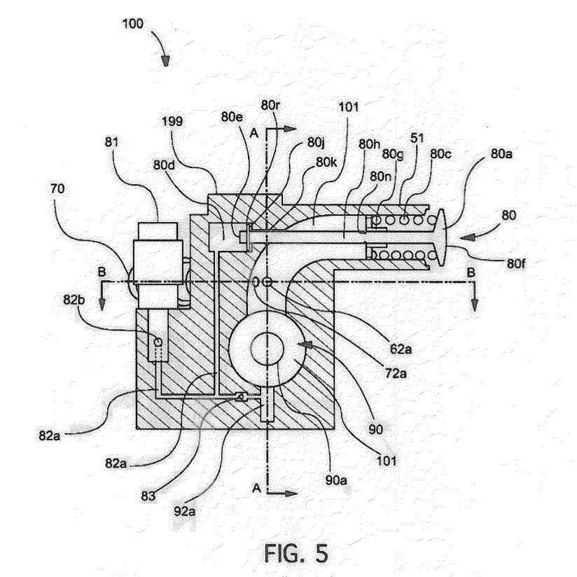

Control valves 70 and 81 (FIG. 1) are preferably solenoid operated valves that are commonly available in the trade. FIGS. 4A-4B show such a generalized control valve 40 that could be used for valves 70 or 81. Generalized control valve 40 controls flow between a first passage 42a and a second passage 42b by energizing or de-energizing solenoid 501, thereby moving valve member 509 with respect to valve seat 508. As depicted in FIGS. 4A-4B, valve 40 is open and passages 42a and 42b are in fluid communication. When valve head surface 507 is positioned against valve seat 508 the valve is closed. Spring 503 causes the valve to be normally closed in the absence of solenoid current. Alternatively, spring 503 can be located within chamber 504 which would result in a normally open valve in the absence of solenoid current. Passage 505 is provided within valve member 509 to equalize pressure between the regulated passages and chamber 504 for easier valve operation.

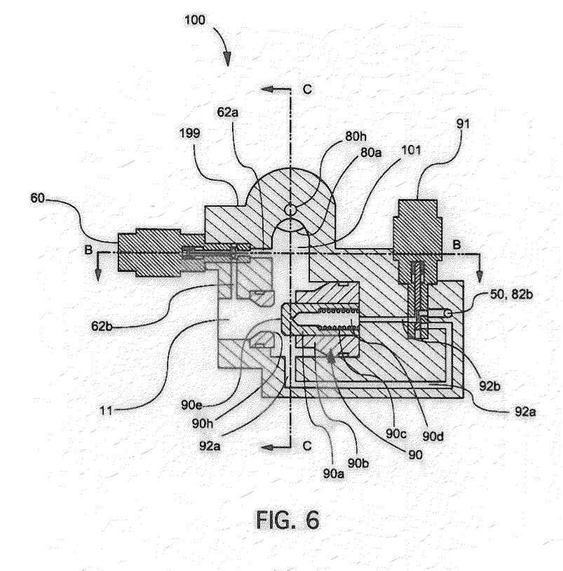

Control valve 91 (FIGS. 1 and 6) is preferably a solenoid operated, 3/2 directional seat valve, or a 2-stage pilot valve, or any similar valve configured to switchably connect pilot passage 92b to either high pressure at line 92a or low pressure at line 82b. Control valve 91 is normally open so that when its solenoid is not energized, a spring force places the valve in a position in which pilot passage 92b is connected with high pressure at passage 92a, allowing valve 90 to close by its internal spring force. When energized, pilot passage 92b is dumped to low pressure at passage 82b, opening valve 90 if sufficient pressure exists in line 11.

Understanding now the areas and forces involved in the operation of the first and second shut-off valves 90 and 80, and the operation of control valves 70, 81, and 91, the overall operation of valve unit 100 (FIG. 1) can be fully described.

Refer now again to FIG. 1 (and to the valve details of FIGS. 2 and 3 as necessary). To open valve unit 100 from the first closed state, the main task is to open primary valve 90 (because secondary valve 80 is already open in the first embodiment). Prior to opening valve 90, valve 70 may optionally be opened (if previously closed) so that actuation line 13 may provide high pressure to the pump/motor displacement actuators to set them to zero displacement if necessary. Primary valve 90 is then opened by the following process that is designed to alleviate undesirable noise. Initially, the second area 90f of valve 90 is at a high pressure because it is in fluid communication with line 92b, which is at high pressure because control valve 91 opens it to passage 101. The first area 90e is at a much lower pressure, because the trapped fluid in line 11 and further down the system would have leaked down during the time valve 90 was closed. Therefore the pressure on the second area 90f dominates, and along with the force of the spring causes the valve member to be in a closed position. Pressurization valve 60 is then opened, pressurizing line 11 by means of pressurization passage 62b. Pressurization valve 60 may be the same type of control valve as valves 70 and 81 (previously detailed in FIG. 4A-4B). Because line 11 is now pressurized, first area 90e is also pressurized, to a pressure equal to that at area 90f. Now, only the spring force is holding the member closed. Pilot valve 91 is then commanded (for example, by energizing its solenoid) to a position in which it opens passage 92b to the low pressure source. This causes the high pressure at the first area 90e to dominate, overcoming the spring force and pushing the member to an open position, where it will be held as long as there is high pressure in passage 101 and low pressure at the second area 90f. Proper timing of the opening of pressurization valve 60 with respect to valve 91 can prevent valve 90 from opening at such a speed that it would create undesired noise.

To open valve unit 100 from the second closed state (of the second embodiment), it is necessary to open both primary valve 90 and secondary valve 80. Because the pressure in passage 101 is likely to have leaked down to a pressure substantially lower than that in the accumulator 24, it would ordinarily be very difficult to open valve 80 against the accumulator pressure by means of a simple actuator. In the invention, valve 80 is opened by fluid flow. First, fluid is pumped by a charge pump (not shown) from a low pressure fluid source into an actuation circuit, which is separate from the other circuits which can be pressurized. Then fluid is pumped through line 11 across primary valve 90 and secondary valve 80, both of which can accept fluid in this direction regardless of their state. Preferably, an engine pump of a hydraulic hybrid vehicle provides the pumping flow into line 11, with the charge pump providing sufficient pressure for actuating the displacement control of the engine pump as necessary until valve 80 has been opened and full displacement control can be achieved. The charge pump may be a priming pump or other auxiliary pump such as for example a deaeration fluid return pump). With valve member 80a (FIG. 3B) having been pushed off the valve seat by flow, and the pressure now being equal across the valve member, spring 80c then retains the valve member 80a in an open position. High pressure fluid has entered the pilot chamber 80d by leakage past clearance 80k in the fit of the stem of the valve member, thereby being present to act against the second area 80e, with pilot valve 81 being in a closed position.

When valve 80 has been successfully opened and pumping from line 11 can therefore stop, primary valve 90 can be kept open by having commanded valve 91 to discharge fluid from 92b to low pressure. Alternatively, in the second embodiment, primary valve 90 is kept open by commanding low pressure to its pilot chamber 90d. As described before, if primary valve 90 is allowed to close after pumping stops, it may be commanded open by the same method.

FIGS. 5-7 depict a preferred embodiment of integrated valve unit 100. Here the various valves and circuits described symbolically with respect to FIG. 1 are embodied physically within a common housing.

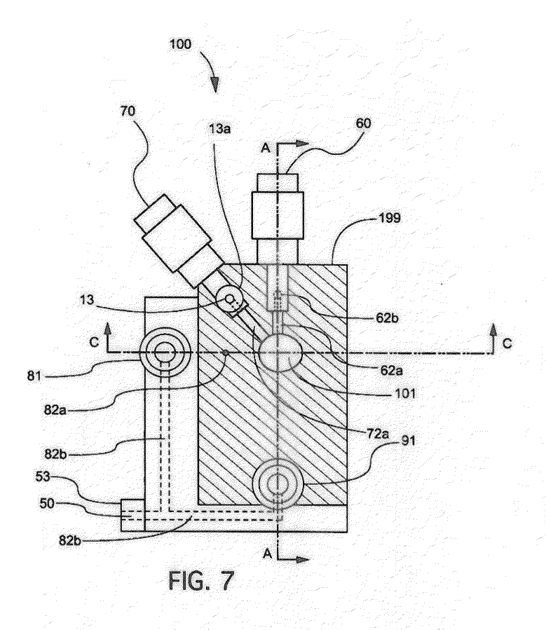

Referring to FIG. 5, secondary valve 80 is preferably implemented as a tulip valve including valve member 80a. Preferably, valve unit 100 is mounted so that valve member 80a extends into the interior of a high pressure accumulator that serves as a high pressure source. Passage 101 unites secondary valve 80 with primary valve 90. Passage 101 continues as an annular passage around valve member 90a to unite with line 11 (seen more clearly in the orthogonal view of FIG. 6). Lines 62a and 72a are seen intersecting with passage 101, and are also seen more clearly in the top view of FIG. 7.

Secondary valve 80 is shown in an open position. In this state, high pressure fluid is exerting pressure on all surfaces of valve member 80a. High pressure fluid is able to enter chamber 80d through clearance 80k and past retainer 80r, and so surface 80e is also at high pressure. Pressures on surfaces of member 80a thereby being balanced, spring 80c provides the primary force holding valve 80 open.

Secondary valve 80 may be closed on command by switching control valve 81 to an open state where it connects passage 82a with low pressure passage 82b. Fluid in chamber 80d is thereby dumped to low pressure, causing second surface 80e to be at a low pressure, allowing the high pressure at first surface 80f to rapidly push the valve closed. Control valve 81 may be then switched back to a closed position to prevent leakage. Chamber 80d will then gradually equalize pressure with fluid in passage 101 via clearance path 80k.

Spring 80e is sized to provide a flow fuse function, by exerting a sufficient force to hold valve member 80a open during normal rates of flow into passage 101, but to allow the valve to close under flow pressure past a maximum flow rate. In this situation, flow pressure acts on surface 80f to cause member 80a to compress spring 80c and thereby close valve 80. Fluid in chamber 80d must thereby be displaced by the sweep of surface 80e in order for the valve to close freely. Because control valve 81 is normally closed, an alternate path for escape is provided by check valve 83 which allows fluid to escape volume 80d through passage 82a.

Optional V-notch 80n may be incised around poppet stem 80h at a point near guide 80g to provide a controlled location (or breakaway region) for potential fracture of the poppet stem under stress. If sufficient stress is induced on the poppet stem by a catastrophic event such as shearing off of the valve unit from the high pressure accumulator, it is preferable that the stem break rather than deform in such a manner that it no longer moves freely within guide 80g, which could prevent valve member 80a from seating properly and sealing the accumulator. Even if stem 80h is fractured, valve member 80a will remain firmly seated and the accumulator fluid will remain isolated due to pressure acting at surface 80f. Preferably, the V-notch is a 60 degree groove with 0.25 mm root radius, or a similar dimension to provide necessary stem strength to withstand normal use while assuring that any fracture of the stem will occur at or near the notch. The function of the V-notch 80n in creating a designated breakaway region of reduced fracture strength on stem 80h may alternatively be provided by other means, such as for example a localized thinning of the diameter of stem 80h, a localized heat treatment or similar processing, a static joint of a designed fracture strength, or other suitable means as apparent to one skilled in the art.

Referring to FIG. 6, primary valve 90 is depicted in an open position in which valve member 90a is in a position allowing passage 101 to be united with line 11. In this state, high pressure fluid is exerting pressure on first surface area 90e of valve member 90a, while fluid in chamber 90d is at low pressure because control valve 91 is in a state that connects passage 92b with the low pressure source (via passages 82band 50). Valve member 90a thereby remains in an open position.

Primary valve 90 may be closed on command by switching control valve 91 to a (preferably default) state where it connects passage 92b with high pressure (via passage 92a). Pressure in chamber 90d thereby equalizes with pressure at first area 90e. Pressures on surfaces of member 90a thereby being balanced, the force of spring 90c dominates, and moves member 90a to seat it against valve seat 90h, closing the valve.

Primary valve 90 is opened by causing high pressure to act on first surface 90e while high pressure is in chamber 90d. With primary valve 90 having been initially closed, it is expected that the high pressure fluid thereby trapped in line 11 will gradually leak down through other parts of the circuit and be at a much reduced pressure when primary valve 90 is to be opened again. However, because secondary valve 80 is ordinarily kept open, high pressure remains in passage 101. To reintroduce high pressure at surface 90e in order to open the primary valve, pressurization valve 60 is opened to connect passage 101 with passage 11. Passage 11 thereby becomes pressurized to a value near the pressure in passage 101. Simultaneously (or nearly so), control valve 91 is switched to a state in which it connects passage 92b (and hence chamber 90d) with low pressure. Valve member 90a will then be moved into the open position against the force of spring 90c. The timing of the switching of valve 91 with respect to that of valve 60 may be selected so as to reduce or eliminate noise upon opening.

Referring now to FIG. 7, displacement pre-positioning valve 70 may also be seen. Passage 72a connects passage 101 to valve 70. When valve 70 is in an open state, passage 72a is connected with displacement actuation line 13, providing high pressure to displacement actuators of the pump/motors. During normal operation, valve 70 remains open so that displacement may be controlled. Valve 70 may again be switched to a (preferably default) closed position on shutdown, after the pump/motors have been set to zero displacement, in order to prevent leakage while the system is shut down.

The invention herein is intended to be limited solely by the claims.

1. An integrated valve unit for selectively shutting off fluid flow from a high pressure hydraulic accumulator to a hydraulic circuit on a hydraulic hybrid vehicle, wherein the hydraulic circuit comprises a principal power-producing portion of the circuit and one or more connected actuation circuits, comprising:
a primary shut-off valve configured to selectively shut off fluid flow from the high pressure accumulator to the power-producing portion of the circuit without shutting off fluid flow from the high pressure accumulator to one or more of the actuation circuits;
a secondary shut-off valve configured to shut off fluid flow from the high pressure accumulator to both the power-producing portion of the circuit and all of the actuation circuits when the secondary shut-off valve is closed, and configured to be reopened by pumping fluid from the hydraulic circuit into the high pressure accumulator; and
a common housing enclosing the primary and secondary shut-off valves.

2. The integrated valve unit of claim 1, wherein the secondary shut-off valve is configured to only reopen by means of pumping fluid from the hydraulic circuit into the high pressure accumulator.

3. A high pressure fluid supply valve for a hydraulic circuit, comprising:
a housing;
a first port, for connection with a high pressure side of a hydraulic circuit;
a second port, for connection with a high pressure fluid supply;
a third port, for connection with a pump/motor actuation circuit;
a fourth port, for connection with a low pressure fluid supply;
a first passage, connecting the first port and the second port;
a second passage, connecting the first passage and the third port, and connected to the first passage at a first juncture;
a first valve, disposed on the first passage between the first juncture and the first port, for controlling fluid flow to the hydraulic circuit;
a first pilot valve, having a high pressure connection with the first valve and a low pressure connection with the fourth port, and controlling a state of the first valve by controlling a pressure at a first pilot area at the first valve;
a second valve, disposed on the first passage between the first juncture and the second port, for controlling fluid flow from the high pressure fluid supply;
a second pilot valve, having a high pressure connection with the second valve and a low pressure connection with the fourth port, and controlling a state of the second valve by controlling a pressure at a second pilot area at the second valve;
a third valve, disposed on the second passage between the first juncture and the third port, for controlling fluid flow to the actuation circuit;
a third passage, connected to the first passage at a juncture between the first valve and the second valve and at a juncture between the first valve and the first port; and
a fourth valve, disposed on the third passage;
wherein the passages, valves, and ports are integrated into said housing.

4. The valve of claim 3, wherein the first and second valves are configured to allow fluid flow toward the high pressure fluid supply, and to selectively prevent flow in the opposite direction.

5. The valve of claim 4, wherein:
the first valve includes a first valve member, two valve ports, a first pilot area, and a spring, and is configured to be closed and opened by positioning of the first valve member;
the first valve is opened by having a high pressure at both valve ports and a low pressure at the first pilot area, and
the first valve is closed by force of the spring when pressure is substantially equal at both valve ports and the first pilot area;
the second valve has a second valve member and a second pilot area and is configured to be closed and opened by movement of the second valve member onto or of of a valve seat;
the second valve is opened by moving the second valve member off the valve seat by force of fluid flow toward the high pressure fluid supply,
closing of the second valve is opposed by having a high pressure on the second pilot area, and
the second valve is closed by removal of said high pressure.

6. The valve of claim 5, wherein:
the first valve is a piloted cartridge valve;
the second valve is a tulip valve having a valve stem and a valve head;
the tulip valve is oriented such that the valve head is disposed substantially within a high pressure accumulator and the valve stem is substantially outside the accumulator; and
the second pilot area is at an end of the valve stem opposite the valve head.

7. The valve of claim 6, wherein the valve stem is configured with a breakaway region having a reduced strength such that a fracture of the stem would be most likely to occur within the breakaway region.

8. The valve of claim 7, wherein the breakaway region includes a region of reduced stem thickness.

9. The valve of claim 8, wherein the reduced stem thickness is a v-notch having a root radius.

10. A method for opening a hydraulic circuit to a high pressure fluid supply, wherein the hydraulic circuit includes an over-center pump/motor, and wherein the hydraulic circuit has a valve unit comprising first and second valves for controlling fluid flow from the high pressure fluid supply to the hydraulic circuit, a third valve for controlling fluid flow to actuation circuit for the over-center pump/motor, and a fourth valve for equalizing pressure across the first valve; comprising the steps of:
if the first valve is in a closed state and the second valve is in an open state:
opening the third valve, thereby pressurizing the actuation circuit for the over-center pump/motor;
positioning the over-center pump/motor to zero displacement;
opening the fourth valve, thereby substantially equalizing pressure across the first valve; and then
opening the first valve.

11. A method for opening a hydraulic circuit to a high pressure fluid supply, wherein the hydraulic circuit includes an over-center pump/motor, and wherein the hydraulic circuit has a valve unit comprising first and second valves for controlling fluid flow from the high pressure fluid supply to the hydraulic circuit, and a displacement actuation circuit for changing displacement of the over-center pump/motor; comprising the steps of:
if both the first valve and second valve are in a closed state:
pressurizing the displacement actuation circuit via a charge pump;
positioning the over-center pump/motor to zero displacement;
placing the second valve in an open position by pumping fluid through the second valve into the high pressure fluid supply, and
holding the second valve in an open position by means of a spring force and a hydrostatic force of fluid being substantially trapped in a pilot chamber of the second valve.

12. The method of claim 11, wherein said pumping is performed by an engine pump of a hydraulic hybrid vehicle.

13. The method of claim 12, wherein, prior to said pumping, a displacement actuation circuit for the engine pump is pressurized by means or a charge pump, and said engine pump is actuated to a selected displacement.

14. A method for closing a high pressure fluid supply to a hydraulic circuit, wherein the hydraulic circuit includes an over-center pump/motor, first and second valves for controlling fluid flow from a high pressure fluid supply to the hydraulic circuit, a third valve for controlling fluid flow to an actuation circuit for the over-center pump/motor, and a fourth valve for equalizing pressure across the first valve; comprising the steps of:
positioning the over-center pump/motor to zero displacement;
closing the third valve;
closing the first valve; and
closing the fourth valve.

15. The method of claim 14, further comprising leaving the second valve open.
